(19) United States
(12) Patent Application Publication
(10) Pub. No.: US 2006/0138264 A1
(43) Pub. Date: Jun. 29, 2006

(54) Mill with eccentric rotor

(75) Inventors: Arthur Lodewyk Coert, Queensland (AU); Raymond Lawrence Towers, Queensland (AU)

Correspondence Address: YOUNG & THOMPSON, 745 SOUTH 23RD STREET, 2ND FLOOR, ARLINGTON, VA, 22202, US

(73) Assignee: INTELLECT PRODUCTS PTY LTD., QUEENSLAND (AU)

(21) Appl. No.: 11/358,110

(22) Filed: Feb. 22, 2006

Related U.S. Application Data
(63) Continuation of application No. 10/333,791, filed on Jan. 24, 2003.

(30) Foreign Application Priority Data
Jul. 24, 2000 (AU) PQ 8952

(51) Int. Cl. B02C 13/09

(52) U.S. Cl. 241/189.1; 241/284

(57) ABSTRACT

A mill for producing finely divided particulate material having a mill housing, a rotor adapted to rotate within the housing, an inlet for stock and an outlet for the finely divided particulate material, the rotor having at least one hammer, the hammer moves in direction of hammer travel and passes into close proximity with a milling surface to finely divide material at the milling surface during each rotation of the rotor, while during a major portion of the hammer travel the hammer is spaced away from any surface, the speed of the hammer through it's travel, position of the hammer, rotor, milling surface and relative dimensions of the hammer, rotor and milling surface being, such that during operation an air flow with the finely divided particulate material entrained therein is generated within the housing opposite the direction of hammer travel.

This application is a continuation of co-pending application Ser. No. 10/333,791, filed on Jan. 24, 2003. Application Ser. No. 10/333,791 is the national phase of PCT International Application No. PCT/AU01/00117 filed on Feb. 8, 2001 under 35 U.S.C. § 371, which claims priority of Australian Application No. PQ 8952 filed Jul. 24, 2000. The entire contents of each of the above-identified applications are hereby incorporated by reference.

### TECHNICAL FIELD

THIS INVENTION relates to a mill and in particular but not limited to a mill for comminuting coal discard to a finely divided particulate.

The present invention can be used to finely divide organic as well as inorganic material.

### BACKGROUND ART

Typically, the processing of organic material involves a drying process.

The present invention arose through the applicant's desire to economically produce a uniform finely divided particulate of about 0.1 mm using existing milling machines. Investigations of existing milling methods revealed that high capital outlays were required and that process costs were too high. For example, existing Raymond Mill technology could be used but the setup costs were found to be too high and so were the processing costs. Also the existing mills have high energy input levels and high wear factors to achieve desired end product characteristics.

The applicant was unable to buy a suitable mill or locate a mill owner prepared to process material for the applicant at an economical price.

As a consequence of the above circumstances the applicant devised the present invention.

### OUTLINE OF THE INVENTION

The present invention resides in a mill having a rotor employing hammers moving at high speed in a housing, the housing having an inlet and an outlet, the rotor being confined within the housing to create turbulence and particle to particle collisions between particles being processed and thereby generating an air flow opposite the direction of rotation of the rotor. The invention also resides in a method for comminuting inorganic or organic material using a housing with an eccentric rotor in which a reverse airflow is generated to discharge finely divided particulate material entrained in the reverse airflow.

The present invention resides in one preferred form in a mill for producing finely divided particulate material from larger input stock, the mill comprising a mill housing to contain the stock during processing, a rotor adapted to rotate within the housing, an inlet for stock and an outlet for the finely divided particulate material, the rotor having at least one hammer, and there being provided a milling surface, the hammer being adapted to move in a direction of hammer travel and to pass into close proximity with the milling surface to finely divide material at the milling surface during each rotation of the rotor, while during a major portion of the hammer travel the hammer is spaced away from any surface, the speed of the hammer through its travel, position of the hammer, rotor, milling surface and the relative dimensions of the hammer, rotor and milling surface, being such that during operation an air flow is generated within the housing opposite the direction of hammer travel. Preferably, the rotor is balanced by having at least two opposed hammers.

Turbulence created within the housings by rotation of the rotor results in vortices which through particle to particle collisions gives a reduced power requirement and improved efficiency. Output capacity is high compared to the size and power requirements of the mill and wear is also reduced.

The housing is preferably shaped to provide a spiral path for particles, the housing having opposed end walls and an arcuate side wall, one said end wall having the inlet, the inlet being adapted to deliver stock into the housing at a position generally centrally of an imaginary circle defined by the travel of the hammers.

The housing is preferably rounded in profile to inhibit buildup of powder in the housing. While any housing can be employed that achieves the reverse airflow, the housing design can be tested by processing to powder and checking for build up of powder in zero pressure areas within the housing. These areas can be adjusted by contouring the housing to eliminate or minimise the low pressure areas. This provides a clean interior. If heat is used a clean interior is important to avoid burning. In most cases heat is not used particularly for food products since it is most desirable to maintain food quality and avoid overheating the material being processed. Any buildup on inner walls of the housing can promote frictional heating which is undesirable.

The outlet is preferably formed in the side wall as a tangential flow passage extending generally tangential to the imaginary circle or parallel to a tangent to the imaginary circle. The housing preferably includes a door or removable end wall to enable to the interior to be serviced.

The rotor is typically mounted within the housing at a eccentric position within the housing, the milling surface comprising an internal surface portion of the side wall of the housing. The rotor is preferably U-shaped having a back portion extending between opposed legs, each leg holding a hammer, the back portion comprising means balancing the rotor to compensate for the position of the hammers on the legs and thereby inhibit flexing of the rotor during use.

The hammers extend the full width of the housing with minimal clearance to limit spillage around the hammers. The rotor back portion preferably has a recess opposite the legs to engage a drive shaft in the recess, the recess being arranged relative to the legs to balance the rotor and inhibit flexing during operation. Typically the rotor back portion includes radially extending strengthening webs to further inhibit flexing during operation. The rotor may include a safety offset enabling retraction of the rotor from the milling surface in the event of jamming. The drive shaft is preferably mounted in a set of high speed bearings including a thrust bearing assembly to allow preloading, and the entire shaft and bearing assembly run in an oil bath to maximise operational lifespan and cool components under working conditions. This again minimises heating of the material being processed.

Drive is usually an electric motor, but it could be more beneficial in isolated areas to use diesel power.

The hammer velocity is typically in the range of 93 to 100 metres per second. Each hammer typically comprises a removable hammer secured to the rotor using fasteners. Preferably each hammer has a removable slip on or bolt on wear strip. The hammer typically extends the full length of the rotor so as to sweep out an imaginary cylinder closely spaced from the end walls of the housing. The housing preferably includes a replaceable ring projecting into the space between the legs of the rotor, the ring having an outer surface spaced closely to free edges of the hammers to inhibit passage of particulate material in an undesirable direction behind the free edges of the hammers.

The housing preferably has two parts, the first part cast in one piece including mountings convoluted housing and backing plate and also a bearing support housing with outer casting for oil bath and mounting feet.

The second part of the housing is an end plate that locks on to lugs and has the entry port and bolt on ring to prevent spillage over the end of the hammers. The end plate is also hinged to allow easy access when replacing wearing parts and normal servicing of apparatus. O'ring seal around the edge of this front plate prevents dust emissions when operating.

The use of an upswept section at the extremity of the hammer will also reduce spillage over the end of the hammer and increase volume through put. This section is part of the replaceable wear strip. The section of hammer at the rear of the housing (the heel) has an extended section that has approximately 30% of the total width to the centre line of the rotor, with a substantially thicker section cast to balance the section to the front of the hammer with 70% of the width carried to produce the working area of the rotor.

The upper side of the hammer has an apexed section that is in a 60/40% distribution of the hammer to the centre line of the hammer, and with the 40% to the leading edge of the hammer. This gives the hammer the same effect as the wing of an aircraft, with the following benefits:

flows the product into a turbulent vortexing action in the active area; and

gives the hammers a self cleaning action to prevent material building up and the possibility of creating a balance problem should one hammer clear and not the other.

The other advantage of the raised section in this area of the rotor gives added strength in the form of a rib to further prevent flexing of the hammer at the high rotational speeds.

The milling surface can comprise a single surface or multiple spaced surfaces can be employed within the housing. Typically the milling surface comprises a retractable sizing block that can be used to adjust the spacing between the milling surface and the hammers to size particles leaving the mill.

In one preferred embodiment the invention includes particle separators downstream of the outlet to selectively remove particles from the outlet air stream. Typically the separators comprise ma series of cyclones set to remove different size particles from the outlet air stream.

### BRIEF DESCRIPTION OF THE DRAWINGS

In order that the present invention can be more readily understood and be put into practical effect reference will now be made to the accompanying drawings which illustrate a preferred embodiment of the present invention and wherein:

FIG. 1 is a front view illustrating a mill made according to the teachings of the present invention and showing typical particle flow arrowed;

FIG. 2 is a side view of the mill of FIG. 1;

FIGS. 3 and 4 are respective plan and elevation views illustrating a typical rotor;

FIG. 5 is a perspective view cut away and showing one end of a typical rotor with a removable hammer section; and

FIG. 6 is a schematic diagram illustrating the use of three cyclones for particle separation.

### METHOD OF PERFORMANCE

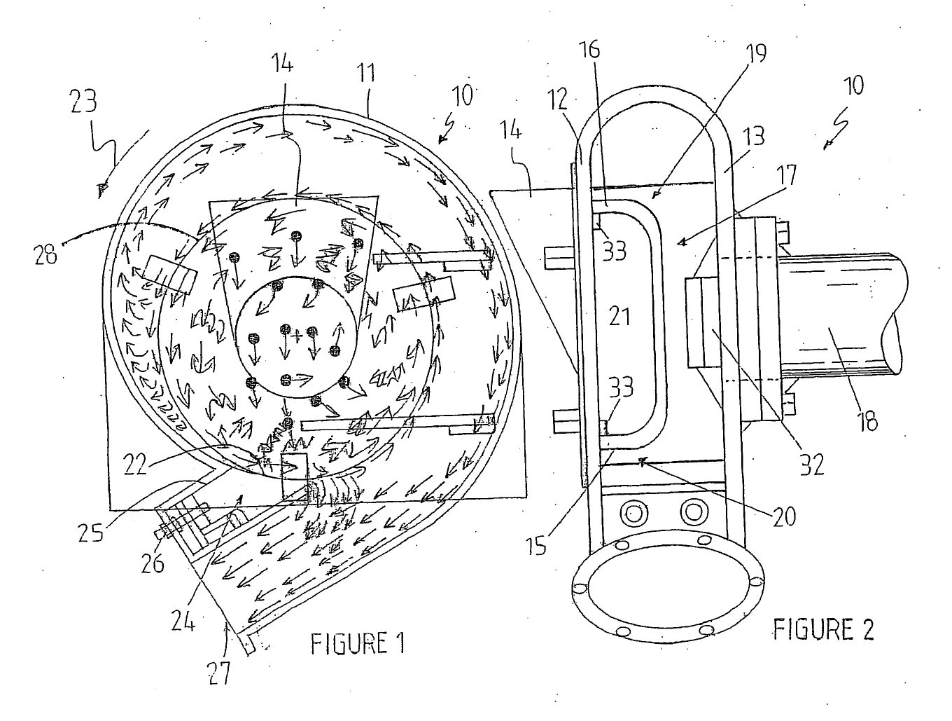

Referring to the drawings and initially to FIGS. 1 and 2 there is illustrated a mill 10 comprising a mill housing having an arcuate side wall 11 and end walls 12 and 13 providing a narrow mill housing. Stock enters the housing through an inlet chute 14 where it flows into an imaginary cylindrical chamber defined by the rotation of respective legs 15 and 16 of a U-shaped rotor 17. The rotor is driven by a shaft 18 so that hammers 19 and 20 have a velocity of about 100 meters per second. The rotor is eccentric due to the convolute form of the housing.

Consequently stock entering the housing flows into an imaginary confinement area or chamber shown generally at 21. Due to the high velocity of the blades comminution occurs within the imaginary chamber due to particle to particle collisions. As can be seen in FIG. 1 the rotor is eccentric in its mounting within the housing, the housing is provided with a milling surface at 22 and the hammers 19 and 20 travel very close to this surface with particles being further reduced and being drawn into the outlet air stream. The rotor moves in the direction of arrow 23 and the shape of the housing, position of the milling surface 22 and the velocity of the hammers causes great turbulence within the chamber resulting in output air flow opposite the direction of rotation of the rotor 17.

The milling surface 22 in the illustrated embodiment is provided by a retractable sizing block 24 travelling in a guide-way 25, the sizing block 24 being adjustable in and out using a threaded rod 26.

The housing is provided with an outlet at 27 extending generally at a tangent to an imaginary circle shown at 28 in FIG. 1, the imaginary circle 28 being defined by the line of travel of the hammers 19 and 20.

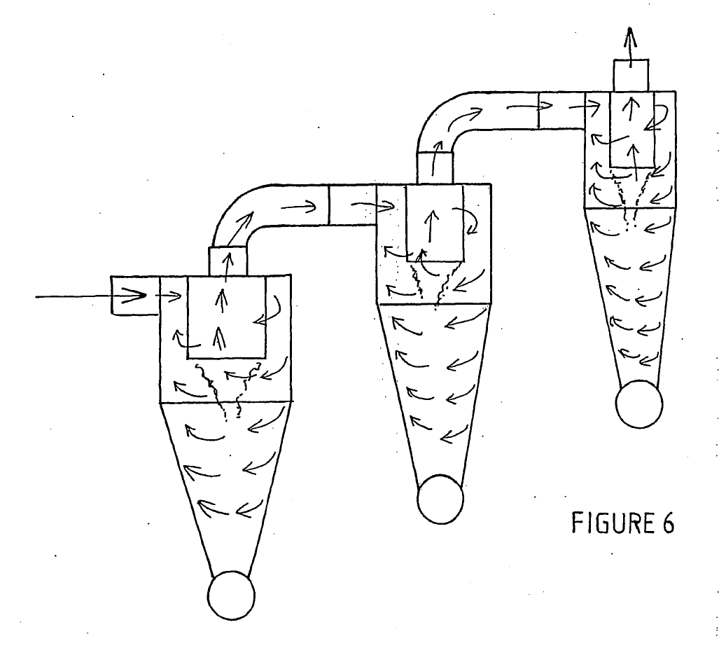

While the present invention enables small particle sizes of the order of 0.1 mm with substantial uniformity, the applicant has found that the sizing block can be used to vary the makeup of and distribution of particle sizes leaving the housing. Cyclones as illustrated in FIG. 6 can be used in the usual way to classify different particle sizes should this be desirable.

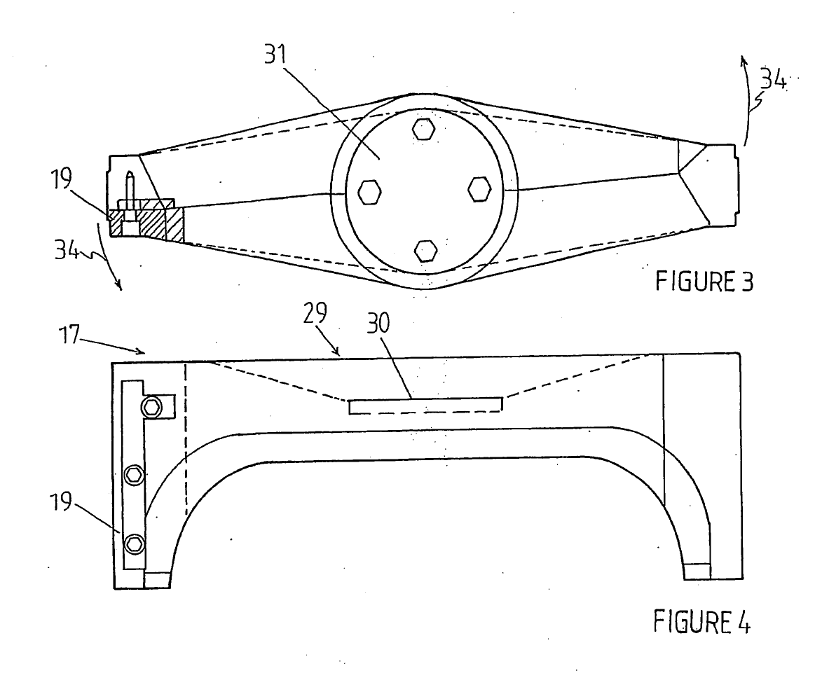

Referring to FIGS. 3 and 4 the rotor 17 is arranged so that it is balanced and inhibits flexing and to this end comprises a recessed back section 29 where a recess 30 has a shaft mounting 31 so that a shaft extension 32 mounts to the rotor generally about its centre of gravity. The rotor is weighted at the back to provide the appropriate balance as required to inhibit flexing. As can be seen in FIG. 2 the hammers 19 and 20 travel just outside a ring 33 which serves to seal the ends of the hammers to prevent particle movement beyond the ends of the hammers.

The hammers 19 and 20 are removably fitted to the rotor 17, the hammer 19 only is shown in FIGS. 3 and 4, the direction of motion of the rotor is given by the arrows 34. The hammers 19 and 20 extend the full width of the housing.

The hammers are at right angles to the rotor and run parallel to the driven axis.

Hammers are cast with a“A”shaped top section designed to perform two major functions. Firstly, it stops build up of materials on top of the hammer when processing which prevents balancing problems. Secondly, this design gives webbed strength to the hammer and reduces flexing problems.

A quick replacement hammer edge made out of wear resistant astable steel alloys and is located in to place and locked with bolts on the end of the hammer.

This replaceable edge has the same apex contours as the hammer except for the end which carries an upright or swept up wing tip to reduce spillage over the end of the hammer and allows more area for impacting.

The apex of the hammer flows up along the 90 curve and blends in with the rotor to give smooth transition to prevent unwanted air flows forming.

Materials to be milled are fed into the feed shute by means of a conveyer at a variable rate, and amperage loading of drive motor is directly related to product feed to allow maximum volume throughput. The materials drop onto rapidly rotating hammers upon entering and are immediately shattered by the leading edges of the hammers and then impacted against themselves and continue from one to the other until they are fine enough to be air swept out for collection by the rotational movement of rotor.

This in effect is caused by the turbulent vortexing action from the rotor action, this has a centripetal action on the materials within this confine, with speed of materials similar to and far exceeding that of the hammers at 100 m/s. The material/material impacting caused by this condition, helps the particle reduction action of the mill.

The special shape of the hammers, allows for the efficiency of the mill by having the airflows assisting in forcing the hammer in a forward motion by their design. The hammer tip speed at 100 mtrs/second is accelerated by six to eight times upon moment of impact by feed material with hammers causing efficient reduction ratios within the confines of the imaginary chamber caused by the rapidly rotating hammers.

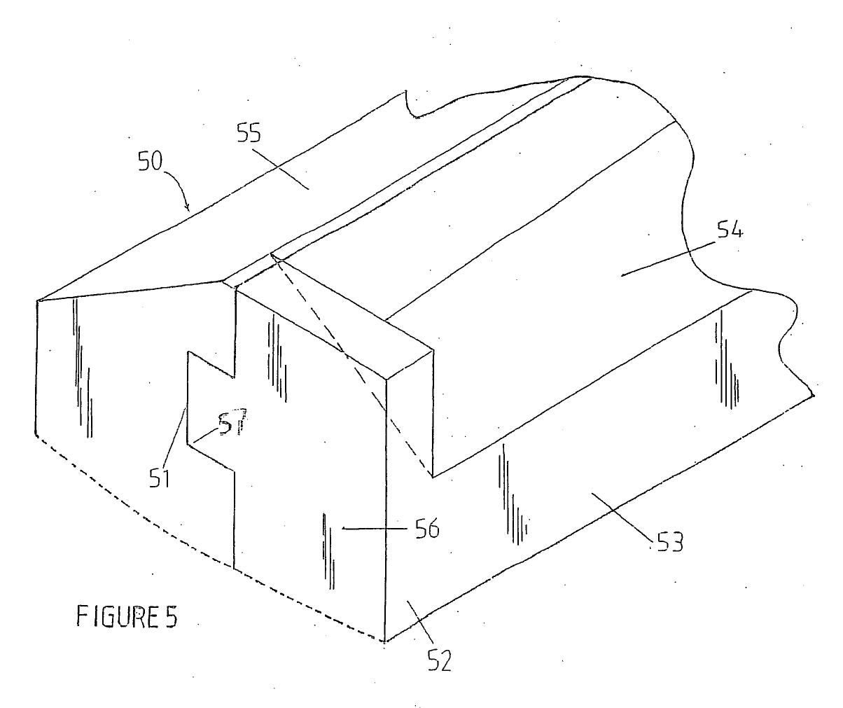

A typical hammer configuration is illustrated in FIG. 5 where the rear of the rotor is shown at 50. The rotor has a slot 51 in which a projection 57 of a removable hammer portion 52 fits, the hammer portion 52 has a narrow front face 53 and an inclined face 54, the rotor being generally A-shaped with an apex at 55. Opposite ends are closed by an end face 56, the shapes being chosen to inhibit spillage over material over the ends of the hammers.

Some of the materials will get through and end up on the outer housing wall where they are forced between the lower part of the hammers and the sizing block and are physically reduced in this fashion. This is where adjustment to the sizing block will give required particle sizing.

When materials are reduced sufficiently to bypass the hammers, but have not reached required size gradings, they are drawn by a low pressure area into a position where they are then forced through a confined space between the lower section of the hammers and the sizing block which has provision for adjustment by means of a linear actuator to allow predetermined fines to be achieved.

The sizing block has two major functions, one is to fine mill the materials.

Secondly, to create a venturi or restriction in airflow created by the rotation of the rotor and hammers. The design causes a wedge shape and creates a build up of pressure and actually reverses the airflow and splits the housing into a counter flow and air floating fines out for collection. This vortex action has a bearing on the efficiency of this machine, and it would be reasonable to assume that northern hemisphere rotation (anti-clock wise) is different to southern hemisphere (clock wise) and this has a bearing also in the efficiency factor. Housing design for northern hemisphere is opposite to that of the southern hemisphere.

The low pressure area just past the sizing block causes the desired effect of introducing the milled materials into the high pressure exiting air flow around the outer circumference of the convoluted space leading in to the exit shute and finally to the outside for collection by means of cyclone separator (or a series of cyclones) and baghouse dust collection system.

Air pressures and flows are characteristic of this mill and notable differences are obtained by varying settings on sizing blocks and also can be achieved by altering shaft speed.

Adjustments of the sizing block to create more clearance, effectively drops back pressure and reduces efficiency as it lowers the pressure areas that cause the turbulence.

Shaft rpm's have two principal effects, one being impacting created, and the continued encasement of product until fine and secondly, by changing inside pressures and effectively air flows the efficiency of the mill can be varied as can particle output size and distribution.

For a mill with a 600 mm rotor diameter, maximum efficiency was found to be at 3000 Rpm's and trails at 2500-2000-1500-1000 Rpm's showed decline in efficiency. Trials above 3500 Rpm's were no more efficient and in fact also has a downward trend in efficiency.

The use of a series of specialised cyclones in series at the exit of the mill provides for a collection of product, and at the same time provide a means of air classification by breaking up the air flows, and allows finer product to settle at a different rate to heaver (coarser) materials.

The angle of the exit shute helps to eliminate a possible build up zone that could occur should excessively wet materials be processed, or unforeseen mechanical mishaps occur.

The cyclone that receives all the air flow and particles entrained therein has a function that allows for the classification of material sizing, and also collection of materials into a rotary valve for redistribution in to the required sections. By adding several more cyclones decreasing in the mean diameters as they progress to keep up the airspeed of the outgoing materials, to separate the finer factions of product due to the decrease in particle size and therefore weight. The relatively clear airflow from the last cyclone is then passed through a dust collection system to completely remove even the finest dust particles.

There is provision for air to bleed off from the top of the cyclone allowing complete pressure to carry lightweight materials into the next classification stage/cyclone.

Whilst the above has been given by way of illustrative example of the present invention many variations and modifications thereto will be apparent to those skilled in the art without departing from the broad ambit and scope of the invention as defined in the appended claims.

1. A mill comprising:
a housing having an inlet for a product to be milled, an outlet for milled particles, a side wall and a milling surface along said wall; and
a rotor mounted eccentrically in said housing and that carries at least one hammer that rotates in a first direction to create turbulence and particle-to-particle collisions within said housing, the eccentric mounting of said rotor being arranged such that the side wall of said housing is outside a periphery of a rotational path of said at least one hammer and spaced from the periphery of said rotational path by a progressively diminishing space, the space diminishing in said first direction and leading to the milling surface where the rotor is in closest proximity to the side wall.

2. The mill of claim 1, wherein the milling surface is in close proximity to the periphery of the rotational path of said at least one hammer in a position that defines said diminishing space as a wedge-shaped region.

3. The mill of claim 2, wherein said milling surface is movable relative to the periphery of the rotational path of said at least one hammer to define a size of the milled particles.

4. The mill of claim 2, wherein said milling surface comprises an internal surface of the side wall of said housing.

5. The mill of claim 1, wherein said rotor has two arms with one said hammer at an end of each of said arms.

6. The mill of claim 5, wherein said rotor is U-shaped with a center portion that is arranged and adapted to inhibit radially outward flexing of said two arms.

7. The mill of claim 6, wherein said center portion has a recess that is arranged and adapted to engage a drive for said rotor.

8. The mill of claim 6, wherein said center portion has radially extending strengthening ribs.

9. The mill of claim 1, wherein said housing defines said diminishing space as a spiral-shaped space for said rotor, said outlet is at one end of said spiral-shaped space, and said inlet is inside the rotational path of said at least one hammer.

10. The mill of claim 1, wherein said outlet is a flow passage extending generally parallel to a tangent of the rotational path of said at least one hammer.

11. The mill of claim 1, wherein said housing has a width in a direction parallel to an axis of rotation of said rotor, and said rotor extends substantially an entirety of said width.

12. The mill of claim 1, wherein said at least one hammer is removably attached to an arm of said rotor.

13. The mill of claim 1, wherein said housing comprises a ring at an inner periphery of the rotational path of said at least one hammer.

14. The mill of claim 1, wherein said at least one hammer comprises a radially outermost part that is upswept.

15. A mill comprising:
a housing having a spiral-shaped interior with an inlet for a product to be milled and an outlet for milled particles;
a U-shaped rotor mounted eccentrically in said spiral-shaped interior and that carries a hammer at each distal end, said rotor rotating in a first direction defining a periphery of a rotational path of said rotor,
said inlet being inside the rotational path of said rotor and said outlet being a flow passage outside the rotational path of said rotor and extending generally parallel to a tangent of the rotational path of said rotor; and
a milling surface in said housing in close proximity to the periphery of the rotational path of said rotor in a position that defines a wedge-shaped region.

16. The mill of claim 15, wherein a gap between said milling surface and the periphery of the rotational path of said rotor opens to said outlet.

17. A method of milling a product comprising the steps of:
inputting the product into a housing and removing milled particles through an outlet to the housing; and
rotating a rotor that is mounted eccentrically in the housing and that carries at least one hammer that rotates in a first direction to create turbulence and particle-to-particle collisions within the housing, the rotation of the rotor being within a periphery of a rotational path of the at least one hammer and providing a milling surface that is in close proximity to the periphery of the rotational path of the at least one hammer in a position that defines a wedge-shaped region.

18. (canceled)
